(19) United States
(12) Patent Application Publication
(10) Pub. No.: US 2017/0034120 A1
(43) Pub. Date: Feb. 2, 2017

(54) NETWORK DEVICE SETTING METHOD AND INFORMATION PROCESSING DEVICE

(71) Applicant: FUJITSU LIMITED, Kawasaki-shi (JP)

(72) Inventor: Makoto Kozawa, Yokohama (JP)

(73) Assignee: FUJITSU LIMITED, Kawasaki-shi (JP)

(21) Appl. No.: 15/219,834

(22) Filed: Jul. 26, 2016

(30) Foreign Application Priority Data
Jul. 31, 2015 (JP) 2015-152928

(51) Int. Cl. H04L 29/12; H04L 29/08

(52) U.S. Cl. CPC H04L 61/2007; H04L 67/10; H04L 61/609

(57) ABSTRACT

A network device setting method for causing a computer to execute a process, the process including causing a basic input/output system to perform processing of generating network setting information in which a place identifier that identifies a place in which a network device is mounted to the computer and a network address are associated with one another; and causing an operating system to perform processing of updating, based on net information in which a device identifier that identifies the network device and the place identifier are associated with one another and the network setting information, configuration information that corresponds to the device identifier with the network address, and setting the network address in the network device using the updated configuration information.

### CROSS-REFERENCE TO RELATED APPLICATION

This application is based upon and claims the benefit of priority of the prior Japanese Patent Application No. 2015-152928, filed on Jul. 31, 2015, the entire contents of which are incorporated herein by reference.

### FIELD

The embodiments discussed herein are related to a network device setting method and an information processing device.

### BACKGROUND

In a server operation environment, if an Internet protocol (IP) address is changed at each startup, access to a server is disabled, and therefore, a static IP address is used in many cases. A “server” herein is an information processing device that provides a service. Also, in a small-scale environment in which there is not enough space for placing a network device that dynamically allocates IP addresses using a dynamic host configuration protocol (DHCP), a static IP address is used.

As described above, in a case where a static IP address is used, a user manually sets an IP address in a network setting file. For example, in Linux (registered trademark), a user sets a device name and an IP address in an ifcfg file that is stored in a hard disk drive (HDD) such that the device name and the IP address are in a one-to-one relationship. The IP address that has been set in the ifcfg file is set in a network interface card (NIC) by an operating system (OS). The “NIC” herein is a LAN card used for performing communication using a local area network (LAN).

FIG. 21 is a diagram illustrating a known NIC setting. In FIG. 21, an OS 91 operates in a server 9, and the OS 91 includes an ifcfg file 92 and a network setting section 93. A user sets an IP address and a device name in the ifcfg file 92 such that the device name and the IP address are in a one-to-one relationship. Then, the network setting section 93 refers to the ifcfg file 92 and sets the IP address in an NIC 94.

Note that, as a known technology related to network setting, there is a technique in which, if network setting is changed in operating an OS, network setting, such as an extended BIOS and the like, at the time when there is not an OS is automatically changed, thereby improving the operability of a system.

Japanese Laid-open Patent Publication No. 2001-230782 discusses related art.

A server includes an HDD slot to which an HDD is attached (mounted), and the HDD is replaceable. When a server is under a test and development, an HDD is detached (dismounted) and attached (mounted) from one to another among a plurality of servers and thus is used. Also, there are cases where, in order to reproduce a failure and the like, an HDD that stores an OS that has been used in a server is moved to another server and is used therein.

In replacing the HDD, a user of a server resets an IP address. FIG. 22 is a diagram illustrating resetting of an IP address. In FIG. 22, a server A and a server B are coupled to one another via a switch 95. The IP address of the server A is 10.24.128.11, and the IP address of the server B is 10.24.128.12. The server A, the server B, and the switch 95 form a network segment the IP address of which is 10.24.128.xx.

An HDD 96a that stores an OS #1 is attached to the server A, and 10.24.128.11 is stored as the IP address of the server A in an ifcfg file 92a of the OS #1. In this case, assume that the HDD 96a that stores the OS #1 is moved to the server B, and another HDD 96b that stores an OS #2 and was previously used in the server A is attached to the server A.

Then, each of the IP address that is stored in the ifcfg file 92b of the server A and the IP address that is stored in the ifcfg file 92a of the server B is 10.24.128.11, and a network trouble occurs. Therefore, a user of a server is desired to change the IP address that is stored in the ifcfg file 92a of the server B from 10.24.128.11 to 10.24.128.12.

Thus, in replacing an HDD, the user of the server resets the IP address in the following manner. (1) Replace an HDD to a server. (2) Unplug a LAN cable from the server to which the HDD was replaced. (3) Start up an OS. (4) Reset an IP address. (5) Connect the LAN cable again.

In this case, if the step of unplugging a LAN cable is forgotten, a problem arises in which a network trouble occurs and communication is not possible.

### SUMMARY

According to an aspect of the invention, a network device setting method for causing a computer to execute a process, the process including causing a basic input output system to perform processing of generating network setting information in which a place identifier that identifies a place in which a network device is mounted to the computer and a network address are associated with one another; and causing an operating system to perform processing of updating, based on net information in which a device identifier that identifies the network device and the place identifier are associated with one another and the network setting information, configuration information that corresponds to the device identifier with the network address, and setting the network address in the network device using the updated configuration information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an operation of a server according to a first embodiment;

FIG. 2 is a table illustrating an example of NIC-IP information;

FIG. 3 is a table illustrating an example of CDN information;

FIG. 4 is a table illustrating an example of a LAN setting table;

FIG. 5 is a table illustrating an example of net information;

FIG. 6 is a diagram illustrating a sequence of network setting according to the first embodiment;

FIG. 7 is a flow chart illustrating an outline of a flow of processing of BIOS;

FIG. 8 is a flow chart illustrating a flow of ACPI table generation processing;

FIG. 9 is a flow chart illustrating a flow of BIOS setting processing;

FIG. 10 is a flow chart illustrating a flow of IP address setting processing;

FIG. 11 is a flow chart illustrating a flow of LAN setting table generation processing;

FIG. 12 is a flow chart illustrating a flow of processing of an OS-IP setting section;

FIG. 13 is a diagram illustrating a configuration of an information processing system according to a second embodiment;

FIG. 14 is a diagram illustrating a sequence of network setting according to the second embodiment;

FIG. 15 is a flow chart illustrating a flow of IP address setting processing;

FIG. 16 is a flow chart illustrating a flow of processing that is performed by a BIOS communication section;

FIG. 17 is a flow chart illustrating an outline of a flow of processing of BIOS;

FIG. 18 is a flow chart illustrating a flow of processing that is performed by an IP address acquisition section;

FIG. 19 is a diagram illustrating a configuration of an information processing system according to a third embodiment;

FIG. 20 is a diagram illustrating a hardware configuration of a server;

FIG. 21 is a diagram illustrating known NIC setting; and

FIG. 22 is a diagram illustrating resetting of an IP address.

### DESCRIPTION OF EMBODIMENTS

Embodiments related to a network device setting method, an information processing device, and a basic input/output system (BIOS) program according to the present disclosure will be described in detail below with reference to the accompanying drawings. Note that the following embodiments are not intended to limit the disclosed technology. The BIOS defines a type of firmware used to perform hardware initialization during the booting process on a computer and to provide runtime services for operating systems and programs.

### First Embodiment

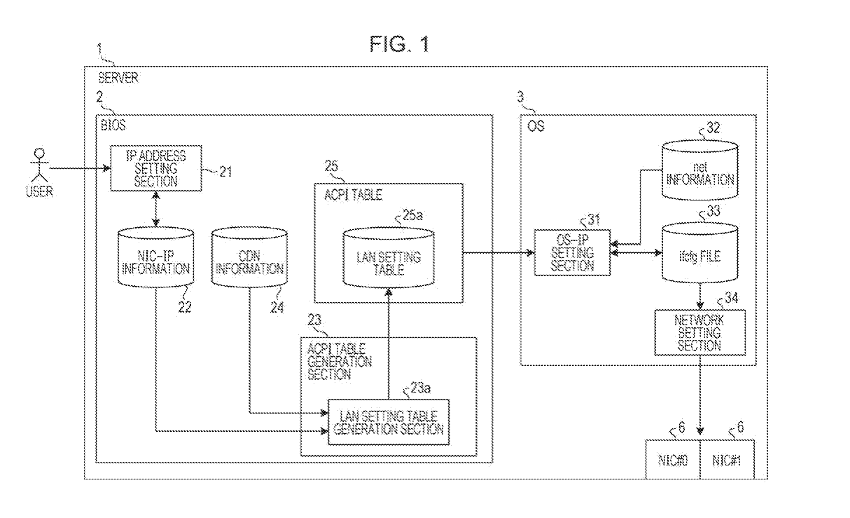

First, an operation of a server according to a first embodiment will be described. FIG. 1 is a diagram illustrating an operation of a server according to the first embodiment. As illustrated in FIG. 1, in a server 1, a BIOS 2 first operates, and an OS 3 that has been started by the BIOS 2 operates next. Also, the server 1 has NIC positions 6 that are represented by NIC#0 and NIC#1. Each of the NIC positions 6 herein indicates the position of an NIC in the server 1.

The BIOS 2 is a firmware that is read from a read only memory (ROM), when the server 1 is powered on, and performs initialization of a central processing unit (CPU) and a memory, generation of an ACPI table, startup of an OS 3, and the like. The advanced configuration and power interface (ACPI) herein is an interface that manages a power source and a related hardware. The server includes one or more processors.

The BIOS 2 includes, as a control unit, an IP address setting section 21 and an ACPI table generation section 23. The IP address setting section 21 receives, as an input, information that associates an NIC position and an IP address with one another from a user, and performs reference to and update of NIC-IP information 22.

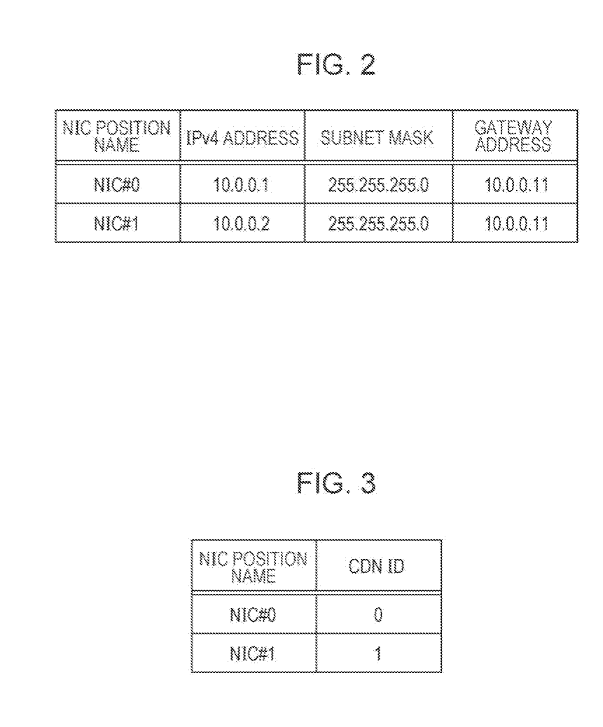

The NIC-IP information 22 is information that associates an NIC position and an IP address with one another. FIG. 2 is a table illustrating an example of the NIC-IP information 22. As illustrated in FIG. 2, the NIC-IP information 22 is information that associates an NIC position name, an IPv4 address, a subnet mask, and a gateway address with one another for each NIC position 6.

Each of the NIC position names is a name that identifies the position of an NIC in the server 1, and specifically, the NIC position names are NIC#0 and NIC#1. The IPv4 address is an IP address of the IP fourth version. The subnet mask is a numerical value used for identifying a network address and a host address of an IP address. The gateway address is the IP address of a device that operates as a gateway. For example, the IP address of the NIC position 6, the name of which is NIC#0, is 10.0.0.1, the subnet mask is 255.255.255.0, and the gateway address is 10.0.0.11.

The ACPI table generation section 23 generates an ACPI table 25. The ACPI table generation section 23 includes a LAN setting table generation section 23a. The LAN setting table generation section 23a refers to the NIC-IP information 22 and consistent device naming (CDN) information 24 and generates, as a part of the ACPI table 25, a LAN setting table 25a.

CDN herein is giving a unique number or name to each of a PCIe slot position and the position of a built-in NIC. The CDN information 24 is information that associates the NIC position 6 and a number that is given by CDN with one another for each NIC position 6. FIG. 3 is a table illustrating an example of the CDN information 24. As illustrated in FIG. 3, the CDN information 24 is information that associates the NIC position name and a CDN ID with one another for each NIC position 6. The CDN ID is a number that is given to the NIC position 6 by CDN. For example, the number that has been given by CDN to the NIC position 6, the name of which is NIC#0, is 0.

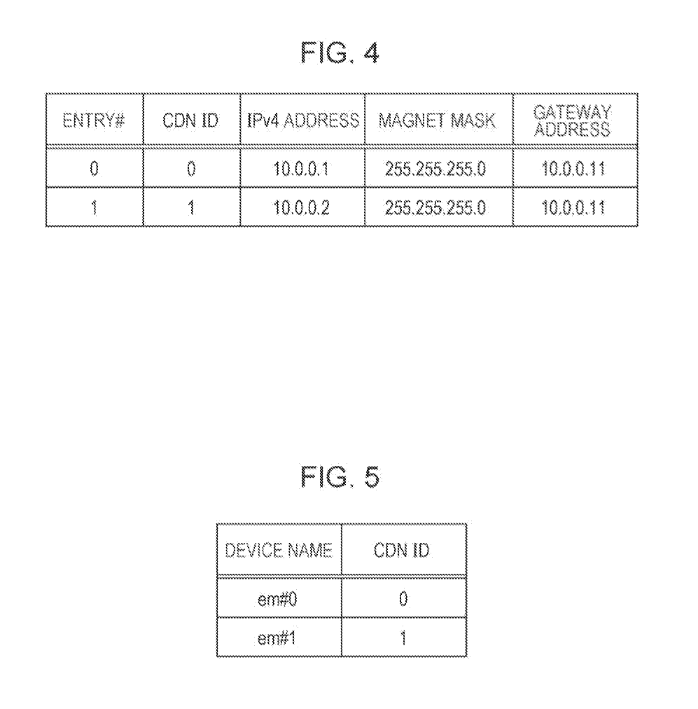

The LAN setting table 25a is a table that associates the CDN ID and an IP address with one another. FIG. 4 is a table illustrating an example of the LAN setting table 25a. As illustrated in FIG. 4, the LAN setting table 25a is information that associates an entry #, the CDN ID, the IPv4 address, the subnet mask, and the gateway address with one another for each CDN ID. The entry # is a number that is given to an entry of the LAN setting table 25a.

For example, in the entry, the number of which is 0, the CDN ID is 0, the IP address is 10.0.0.1, the subnet mask is 255.255.255.0, and the gateway address is 10.0.0.11. Note that the NIC-IP information 22 and the LAN setting table 25a are stored in a memory.

The OS 3 is a basic software that performs resource management of the server 1, scheduling of an application that is executed in the server 1, and the like. The OS 3 includes, as a control unit, an OS-IP setting section 31 and a network setting section 34.

The OS-IP setting section 31 refers to the LAN setting table 25a that has been generated by the LAN setting table generation section 23a and net information 32 and updates an ifcfg file 33. The net information 32 is information that associates a device, such as an NIC and the like, and the CDN ID with one another. FIG. 5 is a table illustrating an example of the net information 32. As illustrated in FIG. 5, the net information 32 is information that associates the device name and the CDN ID with one another for each device. The device name is a name that identifies a device. For example, the device name that has been given to the NIC position 6, the CDN ID of which is 0, is em#0.

The ifcfg file 33 is a network setting file that is associated with a network device, and stores the device name, the IP address, and the like. The OS-IP setting section 31 acquires an initial entry of the LAN setting table 25a, acquires the device name that corresponds to the CDN ID of the entry from the net information 32, searches for the ifcfg file 33 that corresponds to the device name, and updates the IP address and the like of the ifcfg file 33. The IP address and the like herein are the IP address, the subnet mask, and the gateway address. Then, the OS-IP setting section 31 repeats the processing for each of subsequent entries of the LAN setting table 25a, and thus, processes all of entries of the LAN setting table 25a.

The network setting section 34 refers to ifcfg file 33 and sets the IP address and the like in the corresponding NIC.

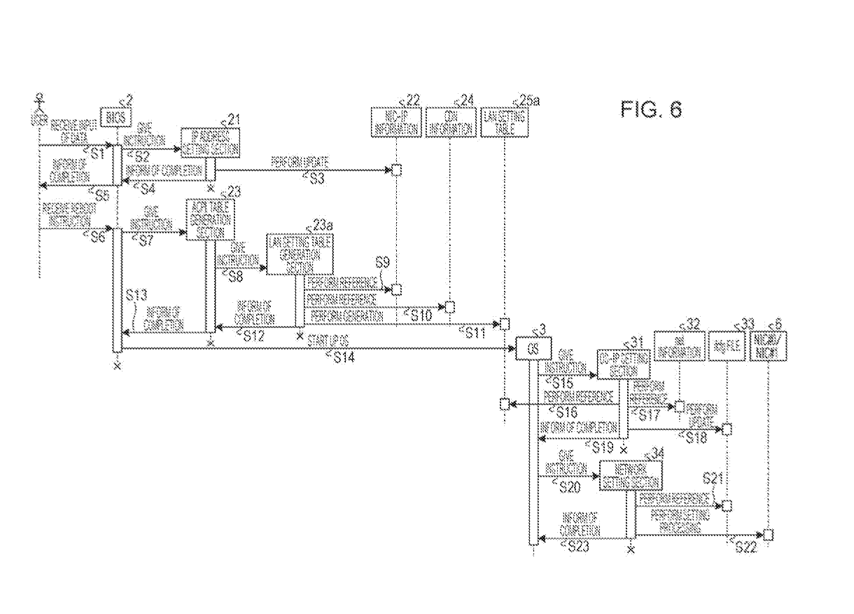

Next, a sequence of network setting according to the first embodiment will be described. FIG. 6 is a diagram illustrating a sequence of network setting according to the first embodiment. Note that, in FIG. 6, a rectangular box with which a part of a dashed line extending in an up and down direction in accordance with each functional section is replaced indicates processing. Also, x that follows the rectangular box indicates the completion of processing of the control unit.

As illustrated in FIG. 6, the BIOS 2 receives an input of data from a user (Step S1), and gives an instruction to update the NIC-IP information 22 to the IP address setting section 21 (Step S2). Then, the IP address setting section 21 updates the NIC-IP information 22 (Step S3), and informs the BIOS 2 of the completion of update of the NIC-IP information 22 (Step S4).

Then, the BIOS 2 informs the user of the completion (Step S5), and receives a reboot instruction from the user (Step S6). Then, the BIOS 2 performs a reboot and, at the time of a startup after reboot, gives an instruction to generate a table to the ACPI table generation section 23 (Step S7). The ACPI table generation section 23 gives an instruction to generate the LAN setting table 25a as a part of the ACPI table 25 to the LAN setting table generation section 23a (Step S8).

Then, the LAN setting table generation section 23a refers to the NIC-IP information 22 and the CDN information 24 (Step S9 to Step S10) and generates the LAN setting table 25a (Step S11). Then, the LAN setting table generation section 23a informs the ACPI table generation section 23 of the completion of reference to the NIC-IP information 22 and the CDN information 24 and generation of the LAN setting table 25a (Step S12), and informs the BIOS 2 of the completion (Step S13). Then, the BIOS 2 starts up the OS 3 (Step S14).

Then, the OS 3 gives an instruction to update the ifcfg file 33 to the OS-IP setting section 31 (Step S15). Then, the OS-IP setting section 31 refers to the LAN setting table 25a and the net information 32 (Step S16 to Step S17), and updates the ifcfg file 33 (Step S18). Then, the OS-IP setting section 31 informs the OS 3 of the completion (Step S19).

Then, the OS 3 gives an instruction to set a network to the network setting section 34 (Step S20). Then, the network setting section 34 refers to the ifcfg file 33 (Step S21) and performs setting of an NIC (Step S22). Then, the network setting section 34 informs the OS 3 of the completion of reference to the ifcfg file 33 and setting of an NIC (Step S23).

As described above, the LAN setting table generation section 23a generates the LAN setting table 25a and the OS-IP setting section 31 refers to the LAN setting table 25a and updates the ifcfg file 33, so that the OS 3 may automatically set an IP address in an NIC.

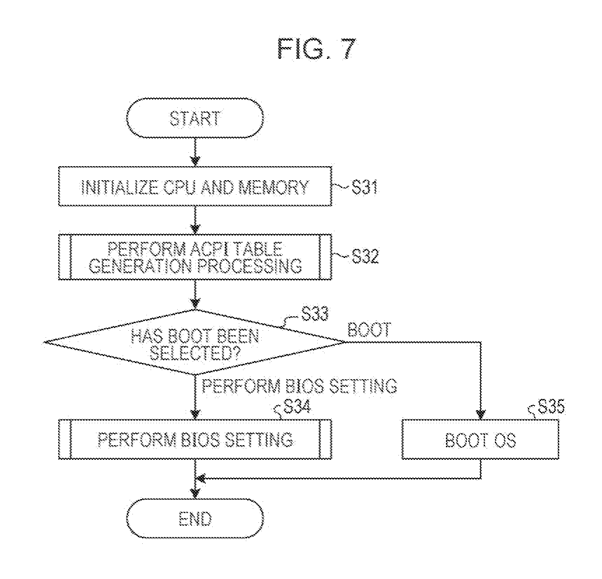

Next, a processing flow of the BIOS 2 will be described with reference to FIG. 7 to FIG. 11. FIG. 7 is a flow chart illustrating an outline of a flow of processing of the BIOS 2. As illustrated in FIG. 7, the BIOS 2 initializes the CPU and the memory (Step S31).

Then, the BIOS 2 executes ACPI table generation processing of generating the ACPI table 25 (Step S32). Then, the BIOS 2 determines whether or not the user has performed boot selection (Step S33) and, if the user has performed not boot selection but BIOS setting selection, the BIOS 2 executes BIOS setting processing of performing BIOS setting (Step S34). On the other hand, if the user has performed boot selection, the BIOS 2 boots the OS (Step S35).

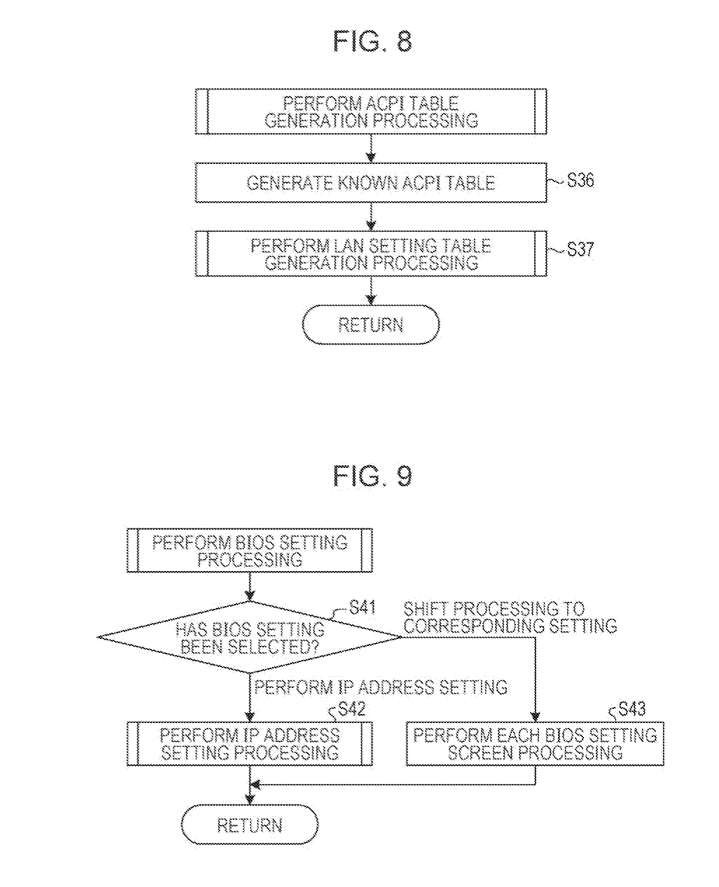

FIG. 8 is a flow chart illustrating a flow of ACPI table generation processing. As illustrated in FIG. 8, the ACPI table generation section 23 generates a known ACPI table (Step S36). Then, the LAN setting table generation section 23a performs LAN setting table generation processing of generating the LAN setting table 25a (Step S37).

FIG. 9 is a flow chart illustrating a flow of BIOS setting processing. As illustrated in FIG. 9, the BIOS 2 determines BIOS setting selection (Step S41) and, if IP address setting has been selected, the BIOS 2 executes IP address setting processing of updating the IP address and the like of the NIC-IP information 22 (Step S42). On the other hand, if IP address setting has not been selected, the BIOS 2 shifts processing to the corresponding setting, and performs each BIOS setting screen processing (Step S43).

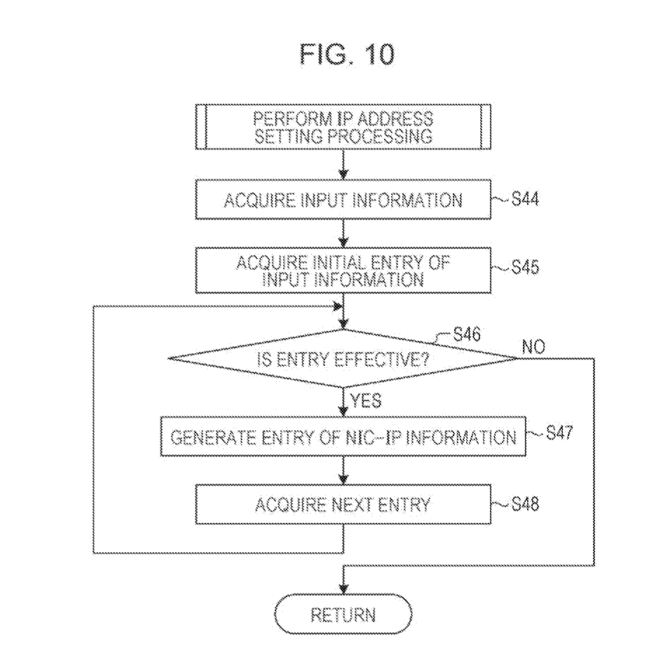

FIG. 10 is a flow chart illustrating a flow of IP address setting processing. As illustrated in FIG. 10, the IP address setting section 21 acquires input information (Step S44) and acquires an initial entry of input information (Step S45).

Then, the IP address setting section 21 determines whether or not the acquired entry is effective (Step S46), if the entry is not effective, the IP address setting section 21 has completed processing for all of entries, and therefore, terminates IP address setting processing. On the other hand, if the acquired entry is effective, the IP address setting section 21 generates an entry of the NIC-IP information 22 (Step S47) and acquires a next entry (Step S48), and the process returns to Step S46.

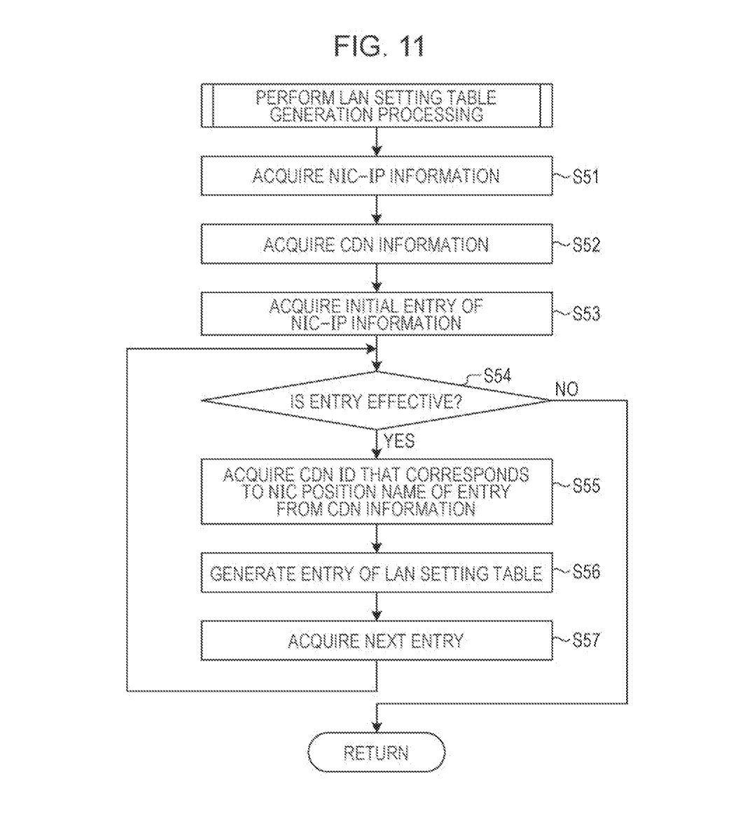

FIG. 11 is a flow chart illustrating a flow of LAN setting table generation processing. As illustrated in FIG. 11, the LAN setting table generation section 23a acquires the NIC-IP information 22 (Step S51), and acquires the CDN information 24 (Step S52).

Then, the LAN setting table generation section 23a acquires an initial entry of the NIC-IP information 22 (Step S53), and determines whether or not the acquired entry is effective (Step S54). As a result, if the entry is not effective, the LAN setting table generation section 23a has completed processing for all of entries, and therefore, terminates LAN setting table generation processing.

On the other hand, if the acquired entry is effective, the LAN setting table generation section 23a acquires the CDN ID that corresponds to the NIC position name of the entry from the CDN information 24 (Step S55), and generates an entry of the LAN setting table 25a (Step S56). Then, the LAN setting table generation section 23a acquires a next entry (Step S57), and the process returns to Step S54.

As described above, the BIOS 2 generates the LAN setting table 25a, based on the NIC-IP information 22 and the CDN information 24, and therefore, the OS 3 may update the ifcfg file 33, based on the LAN setting table 25a.

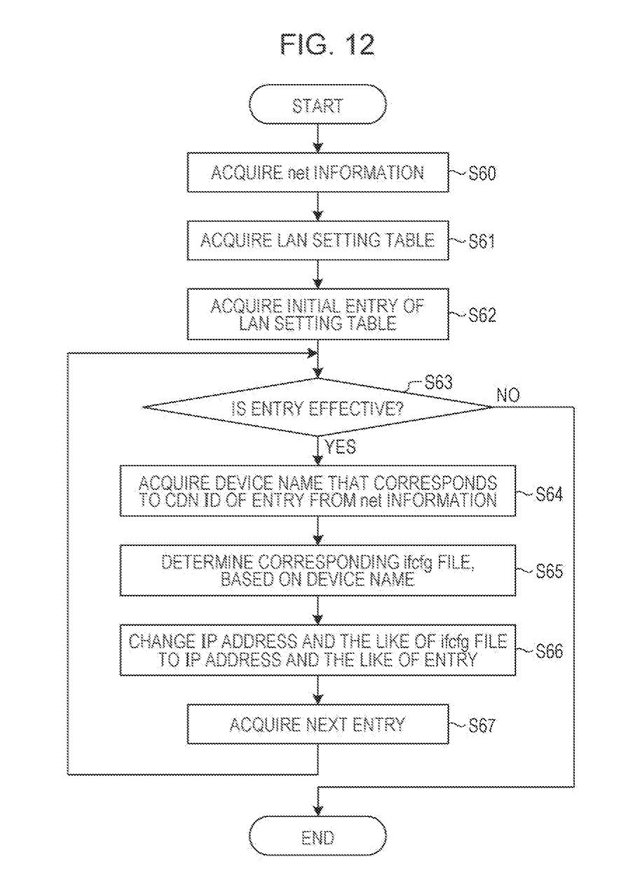

Next, a flow of processing of the OS-IP setting section 31 of the OS 3 will be described. FIG. 12 is a flow chart illustrating a flow of processing of the OS-IP setting section 31. As illustrated in FIG. 12, the OS-IP setting section 31 acquires net information (Step S60), acquires the LAN setting table 25a (Step S61), and acquires an initial entry of the LAN setting table 25a (Step S62).

Then, the OS-IP setting section 31 determines whether or not the acquired entry is effective (Step S63) and, if the entry is not effective, the OS-IP setting section 31 has completed processing for all of entries, and therefore, terminates IP setting processing.

On the other hand, if the acquired entry is effective, the OS-IP setting section 31 acquires the device name that corresponds to the CDN ID of the entry from the net information 32 (Step S64), and determines the corresponding ifcfg file 33, based on the device name (Step S65). Then, the OS-IP setting section 31 changes the IP address and the like of the ifcfg file 33 to the IP address and the like of the entry (Step S66), and acquires a next entry (Step S67), and the process returns to Step S63.

As described above, the OS-IP setting section 31 updates the ifcfg file 33, based on the LAN setting table 25a, so that the OS 3 may automatically set the IP address and the like of the NIC.

As has been described above, in the first embodiment, the BIOS 2 generates the LAN setting table 25a, based on the NIC-IP information 22 and the CDN information 24, and the OS 3 updates the ifcfg file 33, based on the LAN setting table 25a and the net information 32. Then, the network setting section 34 sets the IP address of the NIC using the updated ifcfg file 33. Thus, the OS 3 automatically sets the IP address that has been statically allocated to the server 1, and therefore, the occurrence of a trouble in setting an IP address may be reduced.

Also, in the first embodiment, the IP address setting section 21 of the BIOS 2 generates the NIC-IP information 22, based on information, such as the IP address and the like, which is input by the user, and therefore, the user may input the information, such as the IP address and the like, only once. Accordingly, even when the HDD that stores the OS 3 is attached to another server 1, the user is not desired to change the ifcfg file 33, so that the occurrence of a trouble due to an error in changing the ifcfg file 33 may be reduced.

### Second Embodiment

Incidentally, although, in the first embodiment, a case where the BIOS 2 generates the NIC-IP information 22 has been described, but another device may generate NIC-IP information and the BIOS 2 may acquire the NIC-IP information from the another device. Thus, in a second embodiment, a case where another device generates NIC-IP information and the BIOS 2 acquires the NIC-IP information from the another device will be described.

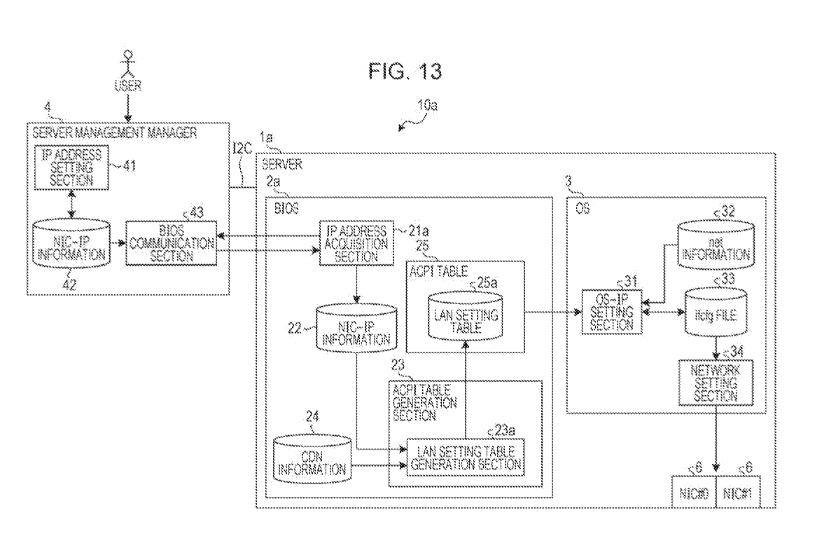

FIG. 13 is a diagram illustrating a configuration of an information processing system according to the second embodiment. As illustrated in FIG. 13, an information processing system 10a according to the second embodiment includes a server management manager 4 and a server 1a. Note that, for convenience of description, each functional section that plays a similar role to that of the corresponding section illustrated in FIG. 1 is denoted by the same reference character as that of the corresponding section illustrated in FIG. 1, and the description thereof will be omitted.

In the server 1a, a BIOS 2a and the OS 3 operate. The server management manager 4 is a device that remotely monitors the server 1a. The server management manager 4 includes an IP address setting section 41, a NIC-IP information 42, and a BIOS communication section 43.

Similar to the IP address setting section 21 illustrated in FIG. 1, the IP address setting section 41 receives information that associates an NIC position 6 and an IP address with one another from a user and performs reference to and update of the NIC-IP information 42. The NIC-IP information 42 is information having a similar configuration to that of the NIC-IP information 22 illustrated in FIG. 1.

The BIOS communication section 43 performs communication with the BIOS 2a. The server management manager 4 and the server 1a are coupled to one another via an I2C, and the BIOS communication section 43 performs communication with the BIOS 2a using the I2C. The BIOS communication section 43 transmits the NIC-IP information 42 to the BIOS 2a.

The BIOS 2a includes, as the control unit, an IP address acquisition section 21a and an ACPI table generation section 23. The IP address acquisition section 21a transmits a request for acquiring the NIC-IP information 42 to the BIOS communication section 43 of the server management manager 4, and receives the NIC-IP information 42 from the BIOS communication section 43. Then, the IP address acquisition section 21a stores the received NIC-IP information 42 as the NIC-IP information 22 in a memory.

As described above, the server management manager 4 generates the NIC-IP information 42, so that the BIOS 2a may acquire the NIC-IP information 22 in a simple manner.

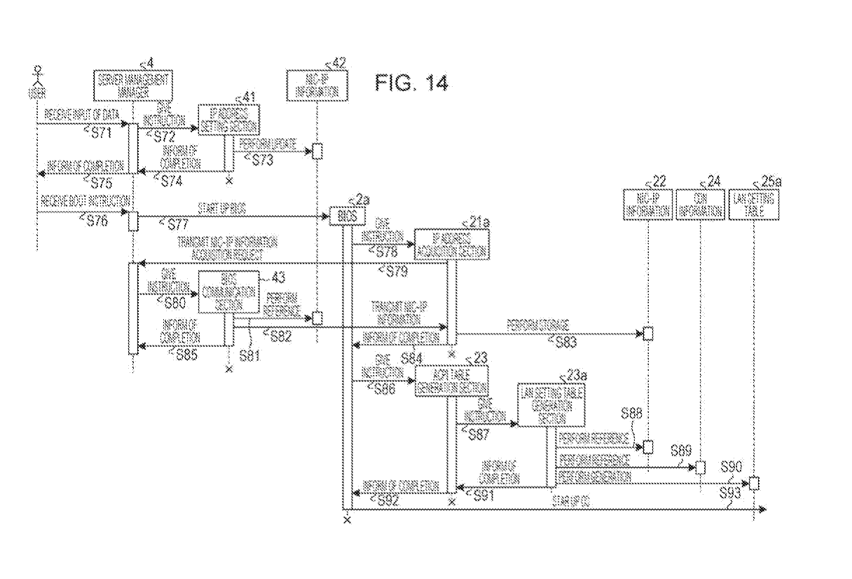

Next, a sequence of network setting according to the second embodiment will be described. FIG. 14 is a diagram illustrating a sequence of network setting according to the second embodiment. As illustrated in FIG. 14, the server management manager 4 receives an input of data from the user (Step S71), and gives an instruction to update the NIC-IP information 42 to the IP address setting section 41 (Step S72). Then, the IP address setting section 41 updates the NIC-IP information 42 (Step S73), and informs the server management manager 4 of the completion of update of the NIC-IP information 42 (Step S74).

Then, the server management manager 4 informs the user of the completion of update of the NIC-IP information 42 (Step S75), and receives a boot instruction from the user (Step S76). Then, the server management manager 4 starts up the BIOS 2a (Step S77).

Then, the BIOS 2a gives an instruction to acquire the NIC-IP information 42 to the IP address acquisition section 21a (Step S78), and the IP address acquisition section 21a transmits a request for acquiring the NIC-IP information 42 to the server management manager 4 (Step S79). Then, the server management manager 4 gives an instruction to transmit the NIC-IP information 42 to the BIOS communication section 43 (Step S80), and the BIOS communication section 43 refers to the NIC-IP information 42 (Step S81) and transmits the NIC-IP information 42 to the IP address acquisition section 21a (Step S82).

Then, the IP address acquisition section 21a receives the NIC-IP information 42, stores the NIC-IP information 42 as the NIC-IP information 22 (Step S83), and informs the BIOS 2a of the completion of receiving and storing the NIC-IP information 42 (Step S84). On the other hand, the BIOS communication section 43 informs the server management manager 4 of the completion (Step S85).

Then, the BIOS 2a gives an instruction to generate a table to the ACPI table generation section 23 (Step S86). The ACPI table generation section 23 gives an instruction to generate the LAN setting table 25a as a part of the ACPI table 25 to the LAN setting table generation section 23a (Step S87).

Then, the LAN setting table generation section 23a refers to the NIC-IP information 22 and the CDN information 24 (Step S88 to Step S89), and generates the LAN setting table 25a (Step S90). Then, the LAN setting table generation section 23a informs the ACPI table generation section 23 of the completion of referring to the NIC-IP information 22 and the CDN information 24 and generating the LAN setting table 25a (Step S91), and the ACPI table generation section 23 informs the BIOS 2a of the completion (Step S92). Then, the BIOS 2a starts up the OS 3 (Step S93).

As described above, the server management manager 4 generates the NIC-IP information 42, so that the BIOS 2a may acquire the NIC-IP information 22 in a simple manner.

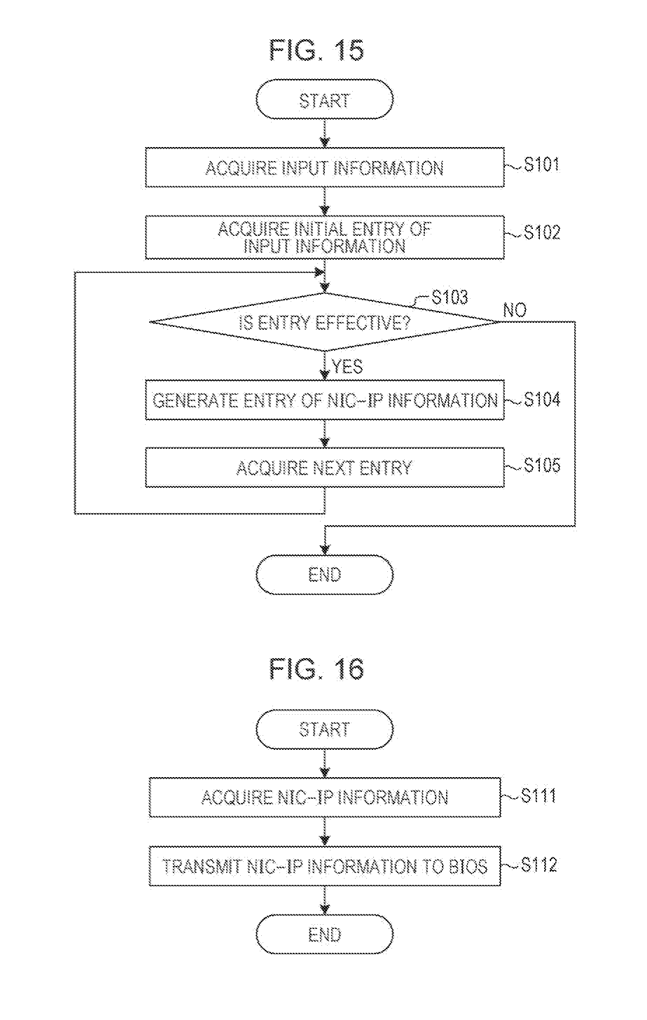

Next, a flow of processing of the server management manager 4 will be described with reference to FIG. 15 and FIG. 16. FIG. 15 is a flow chart illustrating a flow of IP address setting processing that is performed by the IP address setting section 41 of the server management manager 4. As illustrated in FIG. 15, the IP address setting section 41 acquires input information (Step S101), and acquires an initial entry of the input information (Step S102).

Then, the IP address setting section 41 determines whether or not the acquired entry is effective (Step S103), if the entry is not effective, the IP address setting section 41 has completed processing for all of entries, and therefore, terminates IP address setting processing. On the other hand, if the acquired entry is effective, the IP address setting section 41 generates an entry of the NIC-IP information 42 (Step S104) and acquires a next entry (Step S105), and the process returns to Step S103.

FIG. 16 is a flow chart illustrating a flow of processing that is performed by the BIOS communication section 43. As illustrated in FIG. 16, the BIOS communication section 43 acquires the NIC-IP information 42 (Step S111), and transmits the NIC-IP information 42 to the BIOS 2a (Step S112).

As described above, the IP address setting section 41 generates the NIC-IP information 42 and the BIOS communication section 43 transmits the NIC-IP information 42 to the BIOS 2a, so that the BIOS 2a may acquire the NIC-IP information 22 in a simple manner.

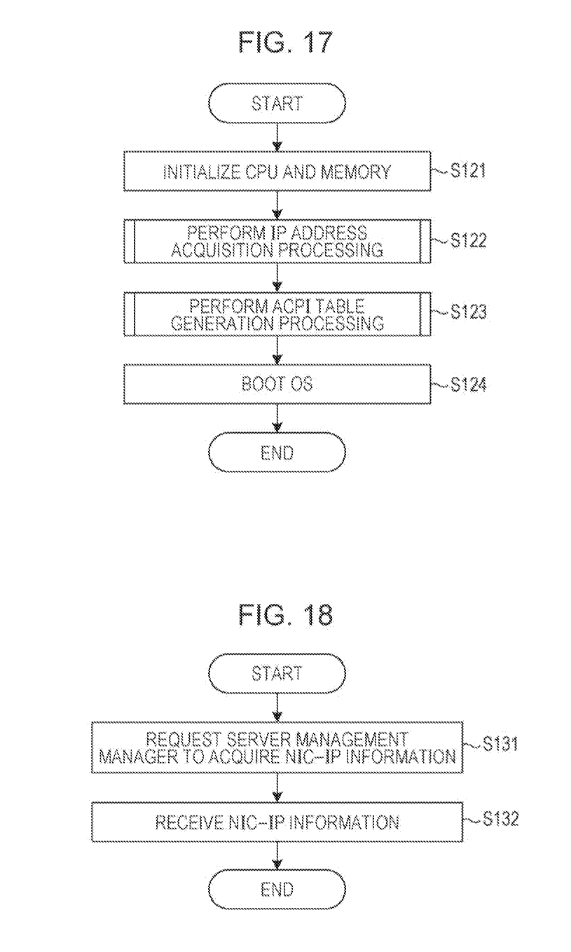

Next, a flow of processing of the BIOS 2a will be described with reference to FIG. 17 and FIG. 18. FIG. 17 is a flow chart illustrating an outline of a flow of processing of the BIOS 2a. As illustrated in FIG. 17, the BIOS 2a initializes the CPU and the memory (Step S121).

Then, the BIOS 2a executes IP address acquisition processing of acquiring the NIC-IP information 42 (Step S122), and executes ACPI table generation processing (Step S123). Then, the BIOS 2a boots the OS (Step S124).

FIG. 18 is a flow chart illustrating a flow of processing that is performed by the IP address acquisition section 21a. As illustrated in FIG. 18, the IP address acquisition section 21a requests the server management manager 4 to acquire the NIC-IP information 42 (Step S131). Then, the IP address acquisition section 21a receives the NIC-IP information 42 from the BIOS communication section 43 (Step S132).

As described above, the IP address acquisition section 21a receives the NIC-IP information 42 from the BIOS communication section 43, so that the BIOS 2a may acquire the NIC-IP information 22 in a simple manner.

As has been described above, in the second embodiment, the IP address setting section 41 of the server management manager 4 receives an input from the user and generates the NIC-IP information 42, and the BIOS communication section 43 transmits the NIC-IP information 42 to the BIOS 2a. Thus, the BIOS 2a may acquire the NIC-IP information 22 in a simple manner.

### Third Embodiment

Although, in the second embodiment, a case where the server management manager 4 receives an input from the user and generates the NIC-IP information 42 has been described, in cloud computing, an IP address is managed by a cloud building server. Then, in a third embodiment, generation of the NIC-IP information 42 in cloud computing will be described.

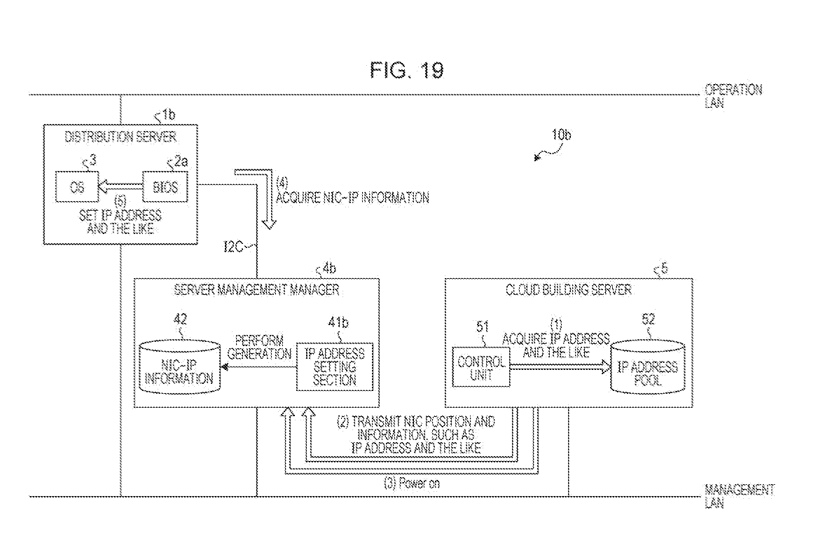

FIG. 19 is a diagram illustrating a configuration of an information processing system according to the third embodiment. As illustrated in FIG. 19, an information processing system 10b according to the third embodiment includes a cloud building server 5, a server management manager 4b, and a distribution server 1b. The cloud building server 5, the server management manager 4b, and the distribution server 1b are coupled to one another by a management LAN that is used for managing the information processing system 10b. Also, the distribution server 1b is coupled to an operation LAN that is used for providing an operation service. Also, the distribution server 1b and the server management manager 4b are coupled to one another via the I2C.

The cloud building server 5 is a management server that builds a cloud and manages the cloud. The cloud building server 5 includes a control unit 51 and an IP address pool 52. The control unit 51 controls cloud building and, for example, distributes a server to a user of cloud computing. The distribution server 1b is a server that is distributed to the user by the cloud building server 5. Note that, although, in FIG. 19, for convenience of description, only a single distribution server 1b is illustrated, a plurality of distribution servers 1b may be provided.

The IP address pool 52 is a pool of free IP addresses. The control unit 51 acquires an IP address and the like from the IP address pool 52 (1), allocates the IP address and the like to the distribution server 1b, and transmits information, such as the IP address and the like that have been allocated, with the position of the NIC to the server management manager 4b (2).

The server management manager 4b is a device that remotely monitors the distribution server 1b. The cloud building server 5 gives an instruction to power on the distribution server 1b to the server management manager 4b (3), and the server management manager 4b powers on the distribution server 1b.

The server management manager 4b includes an IP address setting section 41b and the NIC-IP information 42. Similar to the second embodiment, the IP address setting section 41b receives information that associates an NIC position 6 and an IP address with one another from the cloud building server 5 and performs update of the NIC-IP information 42. Similar to the server management manager 4 described in the second embodiment, the server management manager 4b transmits the NIC-IP information 42 to the distribution server 1b.

Similar to the server 1a described in the second embodiment, the BIOS 2a of the distribution server 1b acquires the NIC-IP information 42 from the server management manager 4b (4). Then, similar to the server 1a described in the second embodiment, the BIOS 2a of the distribution server 1b generates the LAN setting table 25a, based on the NIC-IP information 42. Then, the OS 3 updates the ifcfg file 33, based on the LAN setting table 25a, and sets the IP address and the like in the NIC (5).

As has been described above, in the third embodiment, the server management manager 4b receives the NIC position 6 and the information, such as the IP address and the like, from the cloud building server 5, and generates the NIC-IP information 42. Thus, the BIOS 2a may acquire the NIC-IP information 22 from the server management manager 4b in a simple manner.

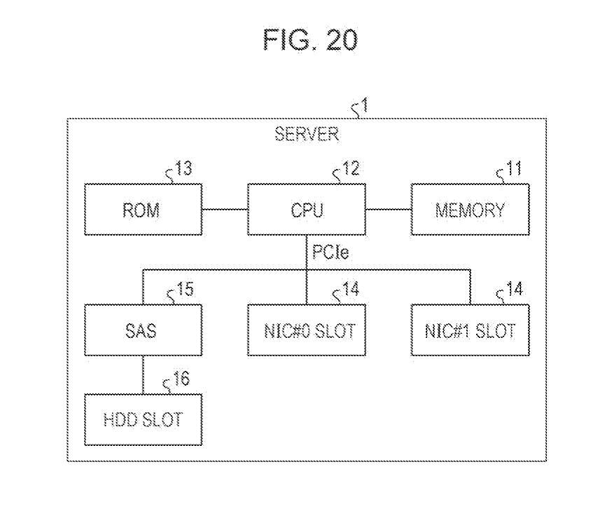

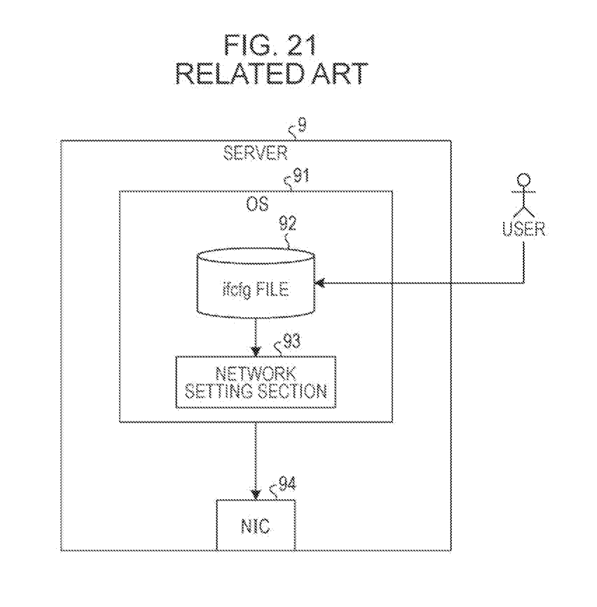

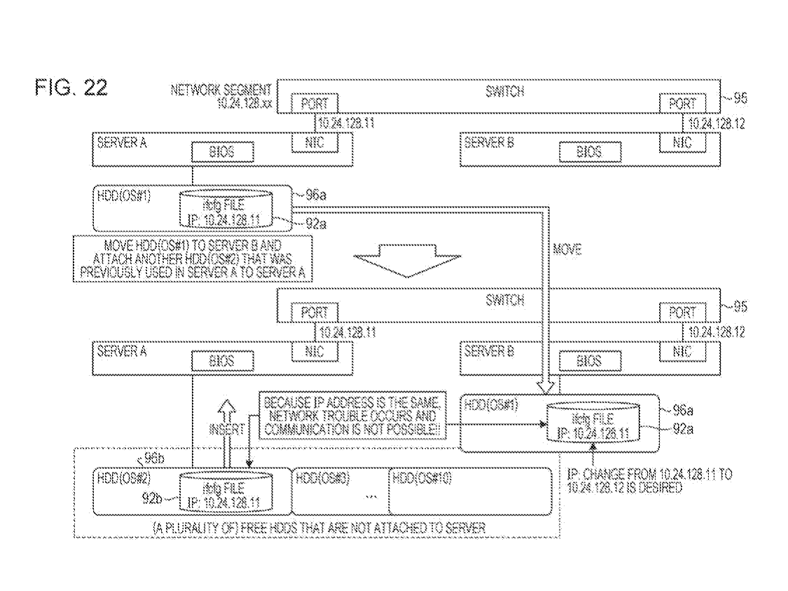

Next, a hardware configuration of the server 1 in which the BIOS 2 and the OS 3 are executed will be described. FIG. 20 is a diagram illustrating a hardware configuration of the server 1. Note that each of the server la and the distribution server 1b has a similar hardware configuration to that of the server 1. As illustrated in FIG. 20, the server 1 includes a memory 11, a CPU 12, a ROM 13, NIC slots 14 represented by an NIC#0 slot and an NIC#1 slot, a serial attached SCSI (SAS) 15, and an HDD slot 16.

The memory 11 is a random access memory (RAM) that stores a program and an intermediate result of execution of the program, and the like. The CPU 12 is a central processing unit that reads the program from the memory 11 and executes the program. The CPU 12 includes a chip set including a memory controller.

The ROM 13 is a read only memory that stores the BIOS 2. Each of the NIC slots 14 is a slot to which an NIC is inserted. The SAS 15 is an interface of the HDD. The HDD slot 16 is a slot to which the HDD is inserted.

Each of the memory 11 and the ROM 13 is coupled to the CPU 12. Also, the NIC slots 14 and the SAS 15 are coupled to the CPU 12 via a PCI express (PCIe). Then, the OS 3 that is executed in the server 1 is stored in the HDD, is read out to the memory 11, and is executed by the CPU 12.

Note that, although, in each of the above-described embodiments, a case where LAN setting is performed has been described, the present disclosure is not limited thereto and, for example, may be similarly applied to a case where setting of another network, such as a wide area network (WAN) and the like, is performed. In one aspect, a network device setting method disclosed herein causes a computer to execute a process including causing a BIOS to perform processing of generating network setting information in which a place identifier that identifies a place in which a network device is attached and a network address are associated with one another. Then, the computer causes an OS to perform processing of updating, based on net information in which a device identifier that identifies the network device and the place identifier are associated with one another and the network setting information, configuration information that corresponds to the device identifier with the network address. Then, the computer causes the OS to perform processing of setting the network address in the network device using the updated configuration information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network device setting method for causing a computer to execute a process, the process comprising:
causing a basic input output system (BIOS) to perform processing of generating network setting information in which a place identifier that identifies a place in which a network device is mounted to the computer and a network address are associated with one another; and
causing an operating system to perform processing of updating, based on net information in which a device identifier that identifies the network device and the place identifier are associated with one another and the network setting information, configuration information that corresponds to the device identifier with the network address, and setting the network address in the network device using the updated configuration information.

2. The network device setting method according to claim 1, wherein
the BIOS performs processing of generating the network setting information, based on place information in which a position identifier that identifies the position of the network device and the place identifier are associated with one another and address information in which the position identifier and the network address are associated with one another.

3. The network device setting method according to claim 2, wherein
the BIOS generates the address information, based on an input from the user.

4. The network device setting method according to claim 2, wherein
the BIOS acquires the address information from a management device that manages the computer.

5. The network device setting method according to claim 4, wherein
the management device acquires the address information from a cloud building device that distributes the computer to the user.

6. An information processing device, comprising:
a memory;
one or more processors coupled to the memory and configured to:
generate, by using a basic input output system (BIOS), network setting information in which a place identifier that identifies a place in which a network device is mounted to the information processing device and a network address are associated with one another; and
by using an operating system, update, based on net information in which a device identifier that identifies the network device and the place identifier are associated with one another and the network setting information, configuration information that corresponds to the device identifier with the network address, and set the network address in the network device using the updated configuration information.

7. A non-transitory, computer-readable recording medium having stored therein a program for causing a computer to execute a process, the process comprising:
acquiring address information in which a position identifier that identifies the position of a network device and a network address are associated with one another; and
generating, based on the acquired address information and place information in which a place identifier that identifies a place in which the network device is mounted to the computer and the position identifier are associated with one another, network setting information in which the place identifier and the network address are associated with one another.
